(19) United States
(12) Patent Application Publication
(10) Pub. No.: US 2013/0113928 A1
(43) Pub. Date: May 9, 2013

(54) Computerized System and Method for Monitoring a Door of a Facility from Afar

(71) Applicant: Joseph FELDMAN, Jerusalem (IL)

(72) Inventor: Joseph FELDMAN, Jerusalem (IL)

(21) Appl. No.: 13/291,393

(22) Filed: Nov. 8, 2011

(51) Int. Cl. G05B 19/00; G08B 13/00; H04N 7/18; G08B 21/00

(52) U.S. Cl. 348/143; 340/539.1; 340/540; 340/687; 340/541; 348/E07.085

(57) ABSTRACT

A dual-communication mode door monitoring system operative in conjunction with a computer network and a cellular network, the system comprising sensory apparatus for collecting data regarding at least one event in which a visitor has come to a door of a monitored facility, the sensory apparatus having a wireless link with the computer network and a cellular communication channel with the cellular network; and at least one node on a computer network and on a cellular network operative for receiving alerts including data from said sensory apparatus; and a communicator, co-located with the sensory apparatus, which is operative to send the data regarding the event to the node, a priori via the wireless link and, as a backup, via the cellular communication channel.

### REFERENCE TO CO-PENDING PATENT APPLICATIONS

None.

### FIELD OF THE INVENTION

The present invention relates generally to monitoring systems and more particularly to systems for monitoring and controlling the door area of a facility.

### BACKGROUND OF THE INVENTION

Conventional technology pertaining to certain embodiments of the present invention is known e.g. as follows:

It is known to provide a button near a door which activates a built-in transmitter. The transmitter sends a radio signal to the doorbell radio receiver inside the building. When the radio signal is detected by the receiver, it activates the doorbell. Telephone technology may be used to wirelessly signal doorbells as well as to answer the doors.

When a visitor presses the button on the door intercom, commercially available products such as the DoorBell Fon claim to ring the phones in a home with a distinctive ring. A user may pick up the phone to converse with the person at the door, it is claimed. The DoorBell Fon system will even work, it is claimed, without phone service, because the system provides the necessary voltage to operate on its own. This allows a user to remain at a distance and answer the door with cordless phones. It is claimed that this also adds valuable convenience in a multi-storey home or building because a user can identify and observe visitors from the other side of a locked door with a 911 instrument in her or his hand.

An “electric strike” is an access control device used for doors. It is operative for allowing the door to close and latch and typically includes a ramped surface which can, upon command, pivot out of the way of the latch allowing the door to be pushed open (from the outside) without the latch being retracted, hence obviating any operation of the knob. In some automatic doorbell systems, an optional lock controller and an electric door strike and power supply allow a user to unlock the door from a phone.

A wide variety of door security products are available e.g. from alibaba.com. iPhone Home Automation Control Apps are described by the following www link: hemagazine.com/iPhone_Home_Automation_Control_Apps. As with home automation touchscreens, the Smartphone has the potential to command any electronic component that can be remotely controlled, for example lights, audio, video, heating, air conditioning, security, spas, swimming pools. By opening the Smartphone application, certain facilities in the home may be controlled. The home's WiFi network or a cellular internet connection is what the Smartphone uses to communicate with a home's automation system. From any point on the globe, it is possible to view, and alter, if necessary, the temperatures of all rooms in a house, as well as the status of the home alarm systems.

A wide variety of Electric Door Strike Remote Unlock mechanisms are known. Automatic door bells are known. A security system with 2-way communication and video is described in published US Application No. 2010/0195810 to Mota et al.

Mobile phones exist which recognize a user's WiFi and prioritize it over the cell network since it is free and faster e.g. as described in the following https reference: discussions.apple.com/thread/2704987?start=0&tstart=0.

“Bump” is a smartphone application which recognizes oscillations caused by shaking the smartphone or striking one smartphone with another. Once the sensor detects a sharp “Bump” motion via the built in Smartphone vibration sensor or accelerometer, the “Bump me” application sends instructions remotely between the Smartphones. Conventional devices, for alerting car-owners to poor driving on the part of their children or other drivers of their car, also remotely recognize oscillations caused by poor driving.

Electric strikes are well known. Wikipedia describes that “An electric strike is an access control device used for doors. It replaces the fixed strike faceplate often used with a latchbar (also known as a keeper). Like a fixed strike, it normally presents a ramped surface to the locking latch allowing the door to close and latch just like a fixed strike would. However, an electric strike's ramped surface can, upon command, pivot out of the way of the latch allowing the door to be pushed open (from the outside) without the latch being retracted (that is, without any operation of the knob) or while excited, the knob or lever can be turned to allow egress from the secured area. Electric strikes generally come in two basic configurations: Fail-secure and Fail-safe.”

The disclosures of all publications and patent documents mentioned in the specification, and of the publications and patent documents cited therein directly or indirectly, are hereby incorporated by reference.

### SUMMARY OF THE INVENTION

Certain embodiments of the present invention seek to provide a computerized system and method for monitoring a door of a facility from afar.

In accordance with an aspect of the presently disclosed subject matter, there is provided a dual-communication mode door monitoring system operative in conjunction with a computer network and a cellular network, the system comprising a sensory apparatus for collecting data regarding at least one event in which a visitor has come to a door of a monitored facility, the sensory apparatus having a wireless link with the computer network and a cellular communication channel with the cellular network; at least one node on a computer network and on a cellular network operative for receiving alerts including data from the sensory apparatus; and a communicator, co-located with the sensory apparatus, which is operative to send the data regarding the event to the node, a priori via the wireless link and, as a backup, via the cellular communication channel.

In accordance with an embodiment of the presently disclosed subject matter, there is further provided a system wherein the node comprises a server operative for activating at least one system response responsive to the data.

In accordance with an embodiment of the presently disclosed subject matter, there is yet further provided a system which is backed up by battery power to ensure continuity of monitoring and action.

In accordance with an embodiment of the presently disclosed subject matter, there is yet further provided a system comprising a power failure identifier which identifies a power failure and sends information regarding the power failure to the node via the battery powered cellular channel.

In accordance with an embodiment of the presently disclosed subject matter, there is yet further provided a system wherein the computer network comprises the World Wide Web and the wireless link comprises WiFi.

In accordance with an aspect of the presently disclosed subject matter, there is yet further provided a computerized alarm generator system, operative in conjunction with a door monitoring system including an internal computer device disposed inside a monitored facility and external sensor apparatus, disposed externally of the monitored facility, for collecting data regarding an event in which a visitor has come to a door of the monitored facility and transferring the data to the internal computer device, the computerized alarm generator system comprising a disconnection sensor sensing a disconnection between the external sensory apparatus and the internal computer device; and a communicator, co-located with the disconnection sensor, operative for sending information regarding the disconnection to a computerized device.

In accordance with an aspect of the presently disclosed subject matter, there is yet further provided a computerized door monitoring system comprising a micro switch operatively associated with a lock on a door of a monitored facility, so as to sense whether or not the door is locked, and a programmed alert generator operative to send an alert to at least one predetermined alert recipient if the door is not locked and at least one predetermined condition is true.

In accordance with an embodiment of the presently disclosed subject matter, there is yet further provided a system wherein the predetermined condition comprises a time trigger defining at least one time at which an alert is to be sent if the door is not locked.

In accordance with an embodiment of the presently disclosed subject matter, there is yet further provided a system wherein the at least one system response includes notifying at least one remote user that connection between an outdoor subsystem sensing information re a caller to the monitored facility, and an indoor computer device disposed internally to the monitored facility, has been interrupted.

In accordance with an aspect of the presently disclosed subject matter, there is yet further provided a computerized door monitoring system comprising a sensor operative to sense a brute force attempt to batter down a door; and an alert generator, actuated by the sensor, operative to alert a remote alert recipient of the brute force attempt to batter down a door or drill out the lock.

In accordance with an embodiment of the presently disclosed subject matter, there is yet further provided a system also comprising upgrading the device software, via the server.

In accordance with an embodiment of the presently disclosed subject matter, there is yet further provided a system wherein the data includes video data and wherein a video transfer priority policy which depends on input from the power failure identifier, governs transfer of video for storage at the node, including at least sometimes transferring video to the node while the power failure identifier indicates there is no power failure, and at least sometimes refraining from transferring video to the node while the power failure identifier indicates there is a power failure.

In accordance with an embodiment of the presently disclosed subject matter, there is yet further provided a system wherein the video data is generated by a video camera, and wherein the system includes a local video data repository, co-located with the video camera, and wherein the video data is stored at the node while the power failure identifier indicates there is no power failure; the video data is stored at the local video data repository while the power failure identifier indicates there is a power failure; and the video data stored at the local video data repository is optionally uploaded to the node when the power failure identifier indicates there is no longer a power failure.

In accordance with an embodiment of the presently disclosed subject matter, there is yet further provided a system wherein, if the wireless link is useable, the video is constantly transferred to and recorded on the node and otherwise, only a pre-defined time-window of video is transferred to and recorded on the node.

In accordance with an embodiment of the presently disclosed subject matter, there is yet further provided a system wherein the door has a latch including a tongue and wherein the micro switch is positioned to sense whether the tongue of the latch is in a first position extending into the door frame indicating the door is locked, or a second retracted position indicating the door is unlocked.

In accordance with an embodiment of the presently disclosed subject matter, there is yet further provided a system wherein the at least one system response includes notifying at least one remote user of a doorbell ring.

In accordance with an embodiment of the presently disclosed subject matter, there is yet further provided a system wherein the at least one system response includes playing a deterrent audio file to a caller, when a doorbell is rung by the caller.

In accordance with an embodiment of the presently disclosed subject matter, there is yet further provided a system wherein the at least one system response includes selectably suspending doorbell ring notifications to remote devices.

In accordance with an embodiment of the presently disclosed subject matter, there is yet further provided a system wherein the at least one system response includes notifying at least one remote user that the door has been opened.

In accordance with an embodiment of the presently disclosed subject matter, there is yet further provided a system wherein the at least one system response includes notifying at least one remote user that there has been a power failure.

In accordance with an embodiment of the presently disclosed subject matter, there is yet further provided a system wherein the at least one system response includes checking if the door is unlocked.

In accordance with an embodiment of the presently disclosed subject matter, there is yet further provided a system wherein the at least one system response includes notifying at least one remote user that temperature in the monitored facility has exceeded pre-set limits.

In accordance with an embodiment of the presently disclosed subject matter, there is yet further provided a system wherein access particulars of at least one computerized device to which the information regarding a disconnection event is to be sent, are stored in a server which also has logic which defines when each computerized device is to be notified.

Also provided, in accordance with at least one embodiment of the present invention, is a dual-communication mode door monitoring method operative in conjunction with a computer network and a cellular network, the method comprising: using sensory apparatus for collecting data regarding at least one event in which a visitor has come to a door of a monitored facility, the sensory apparatus having a wireless link with the computer network and a cellular communication channel with the cellular network; providing at least one node on a computer network and on a cellular network operative for receiving alerts including data from the sensory apparatus; and using a communicator, co-located with the sensory apparatus, to send the data regarding the event to the node, a priori via the wireless link and, as a backup, via the cellular communication channel.

The term “co-located” is used herein to include any situation in which two elements such as the communicator and sensory apparatus above, are generally on the same premises.

Further provided, in accordance with at least one embodiment of the present invention, is a computerized notification generator method, operative in conjunction with a door monitoring system including an internal computer device disposed inside a monitored facility and external sensor apparatus, disposed externally of the monitored facility, for collecting data regarding an event in which a visitor has come to a door of the monitored facility and transferring the data to the internal computer device, the notification generator method comprising using a disconnection sensor for sensing a disconnection between the external sensory apparatus and the internal computer device; and using a communicator, co-located with the disconnection sensor, for sending information regarding the disconnection to a computerized device.

Additionally provided, in accordance with at least one embodiment of the present invention, is a computerized door monitoring method comprising: operatively associating a micro switch with a lock on a door of a monitored facility, so as to sense whether or not the door is locked; and using a programmed alert generator to send an alert to at least one predetermined alert recipient if the door is not locked and at least one predetermined condition is true.

Further provided, in accordance with at least one embodiment of the present invention, is a computerized door monitoring method comprising: providing a sensor operative to sense a brute force attempt to batter down a door; and providing an alert generator, actuated by the sensor, and operative to alert a remote alert recipient of the brute force attempt to batter down a door.

Any suitable output device may be employed to send alerts or information, such as doorbell ring, power off, temperature rise, etc., in accordance with embodiments of the present invention, such as but not limited to a screen display, speaker, or alarm generator of any kind

Also provided is a computer program product, comprising a typically non-transitory computer usable medium or computer readable storage medium, typically tangible, having a computer readable program code embodied therein, the computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a typically non-transitory computer readable storage medium.

Any suitable processor, display and input means may be used to process, display e.g. on a computer screen or other computer output device, store, and accept information such as information used by or generated by any of the methods and apparatus shown and described herein; the above processor, display and input means including computer programs, in accordance with some or all of the embodiments of the present invention. Any or all functionalities of the invention shown and described herein may be performed by a conventional personal computer processor, workstation or other programmable device or computer or electronic computing device, either general-purpose or specifically constructed, used for processing; a computer display screen and/or printer and/or speaker for displaying; machine-readable memory such as optical disks, CDROMs, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor may be employed to compute or generate information as described herein e.g. by providing one or more modules in the processor to perform functionalities described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

### BRIEF DESCRIPTION OF THE DRAWINGS

FIG. 1 is a simplified functional block diagram illustration of an internal computerized subsystem constructed and operative in accordance with certain embodiments of the present invention.

FIG. 2 is a simplified functional block diagram illustration of an external subsystem constructed and operative in accordance with certain embodiments of the present invention.

FIG. 3 is a simplified functional block diagram illustration of a subsystem, all constructed and operative in accordance with certain embodiments of the present invention and operatively associated with a door of a protected facility typically including functionalities for sensing door events and states such as battering down the door, locking and latching, and operating door functions such as unlatching (since typically a handle-controlled latch keeps the door closed).

FIG. 4 is a simplified functional block diagram illustration providing an overview of an example implementation of the present invention in which the internal subsystem of FIG. 1 communicates via a communications and power cable with the external subsystem e.g. of FIG. 2 and with the subsystem operatively associated with the door itself e.g. as in FIG. 3, in which the internal subsystem of FIG. 1 communicates via an Internet or cellular connection with a gateway server which may be remotely located vis a vis the monitored facility.

FIG. 5 is an example target table storing particulars of approved remote users of the apparatus of FIGS. 1-4.

Computational components described and illustrated herein can be implemented in various forms, for example, as hardware circuits such as but not limited to custom VLSI circuits or gate arrays or programmable hardware devices such as but not limited to FPGAs, or as software program code stored on at least one intangible computer readable medium and executable by at least one processor, or any suitable combination thereof A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Data can be stored on one or more intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any time of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

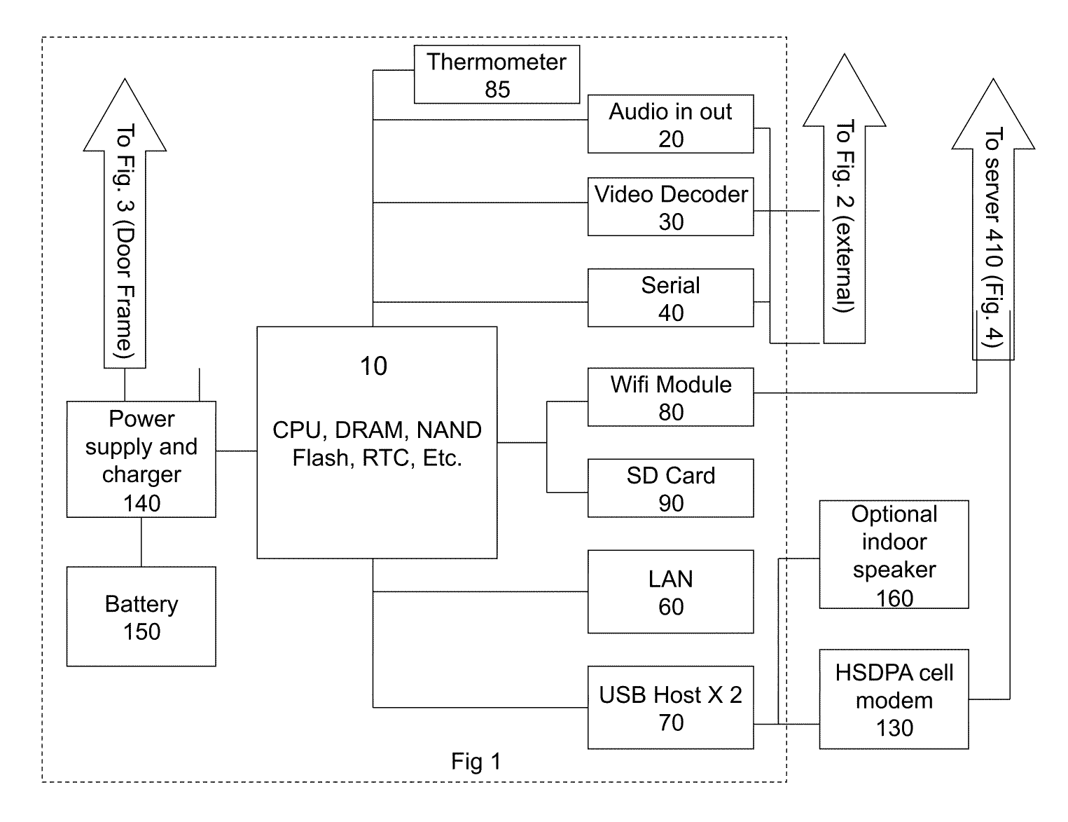

Reference is now made to FIG. 1 which is a simplified block diagram illustration of internal components, intended to be positioned inside a monitored facility, of a doorbell system constructed and operative in accordance with certain embodiments of the present invention. As shown, the apparatus of FIG. 1 may include some or all of the following functional units, suitably interconnected e.g. as shown:

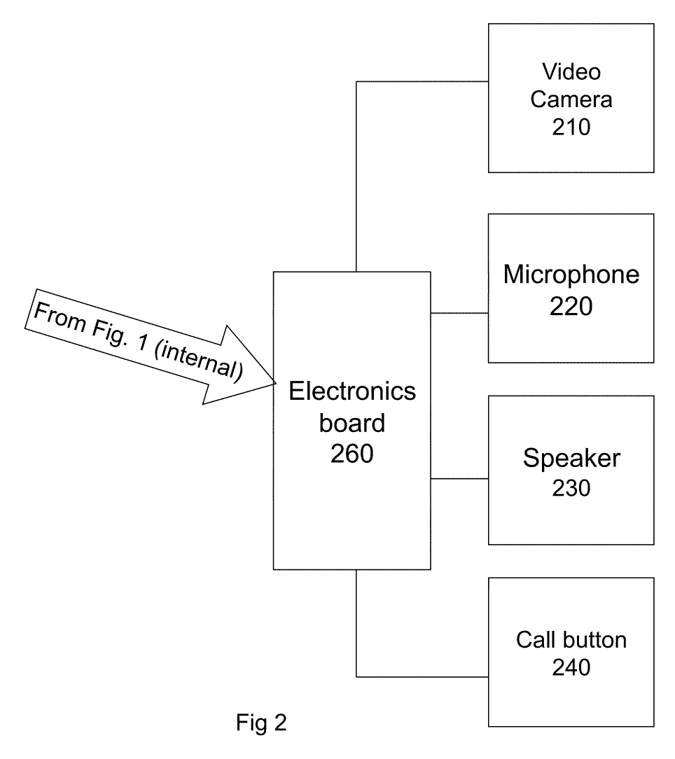

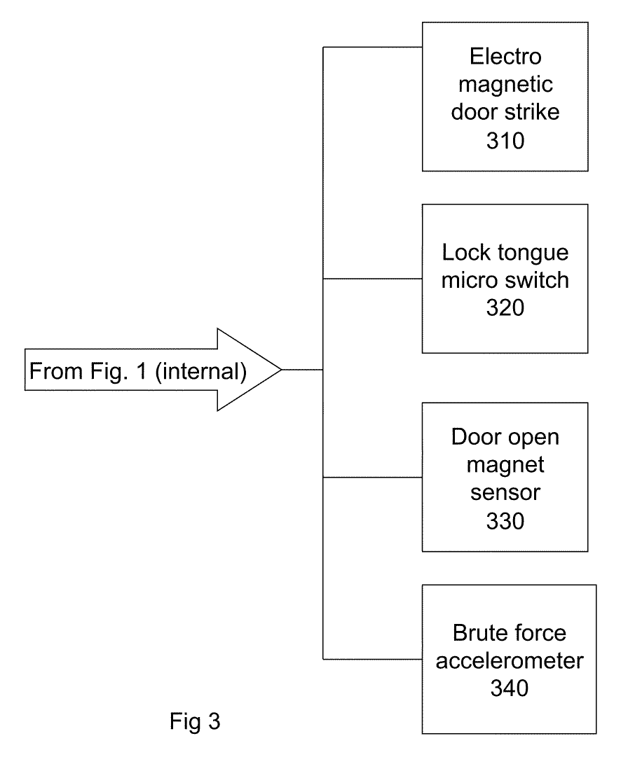

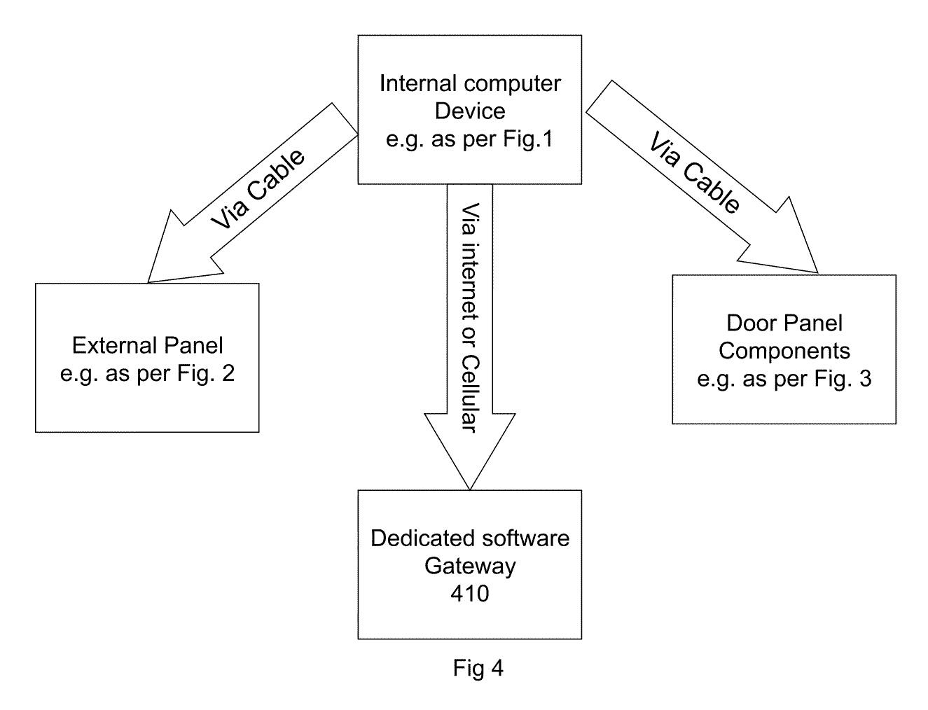

The system typically includes an internal computerized subsystem e.g. as shown in FIG. 1 and an external subsystem e.g. as shown in FIG. 2. A third subsystem is operatively associated with the door itself e.g. as shown in FIG. 3. FIG. 4 is a simplified functional block diagram illustration providing an overview of an example implementation of the present invention in which the internal subsystem of FIG. 1 communicates via a communications and power cable with the external subsystem e.g. of FIG. 2 and with the subsystem operatively associated with the door itself e.g. as in FIG. 3. The internal subsystem of FIG. 1 communicates via an Internet or cellular connection, e.g. as described herein, with a gateway server which may be remotely located vis a vis the monitored facility.

A CPU module 10, typically associated with one or more of a memory such as DRAM, NAND flash, and real time clock (RTC), is connected to some or all of the following: an audio in/out block 20; video decoder 30 and serial block 40; a WIFI subunit typically including a WIFI module 80. The WiFi module and the memory may be separate components and memory 90 such as a memory card (e.g. SD card or other non-volatile memory card); a network such as a LAN 60; and a USB host array 70 typically including at least ×2 USB hosts. Some or all of the above blocks, as well as blocks 140 and 150 described below, are physically disposed internally of an enclosed area e.g. home or facility, to be monitored. Some or all of the audio in/out block 20; video decoder 30 and serial block 40 connect to a door panel subsystem, e.g. as described in FIG. 3.

The cellular modem 130, and an optional indoor speaker 160, connects to the USB port thus providing a cellular communications channel, e.g. for high-speed Internet communication via a SIM card, such as a HSUP A cell modem. The CPU module 10 is typically powered by a power supply and charger 140 and, typically, associated battery 150 which typically also power some or all of the external devices in FIG. 2. Battery 150 may be a rechargeable battery and may provide power to itself and to an outdoor unit for a suitable time period e.g. 48 hours in case of power loss at the conventional A/C electricity outlet. Power failure is typically identified or detected by the CPU 10.

The apparatus of FIG. 2 is typically physically disposed externally of the enclosed area e.g. home or facility, to be monitored. Typically, as is conventional, the internally disposed blocks in FIG. 1 communicate with those blocks which are externally disposed, via an network connection cable which is threaded through a channel e.g. doorbell duct excavated through the wall of the facility, typically adjacent the door.

FIG. 2 is a semi-functional block semi-electrical diagram of an externally located, relative to the door of the monitored facility, subsystem provided in accordance with certain embodiments of the present invention. As shown, the subsystem of FIG. 2 typically includes a camera e.g. video camera 210 constructed, operative and arranged such that the camera 210's field of view includes the space in front of the door (not shown) of the enclosed area such that individuals standing in front of the door are imaged by the camera 210. A microphone 220, typically associated with a suitable amplifier (not shown), may be provided. A speaker 230, typically associated with a suitable amplifier (not shown), may be provided. A call button 240 may be provided. Typically, the camera 210, microphone 220, speaker 230 and call button 240 are associated with a conventional electronics board 260. A single power supply powering the cables interconnecting the subsystem of FIG. 1 with the subsystems of FIGS. 2 and 3 may directly or indirectly power all components. Typically the external panel gets its power from the internal computer and the external panel receives backup power from the battery in the event of a power failure, initiated or otherwise.

FIG. 3 is a simplified functional block diagram illustration of components which are typically installed in the frame of the door of a monitored facility, typically including some or all of the following: electric or electromagnetic door strike 310 typically operative, responsive to a command, to send a pulse that releases the latch so that the door can be pushed open without retracting the handle controlled tongue, microswitch 320 sensing position of the door's lock tongue, door open magnet detector 330 and brute force accelerometer 340. Any suitable commercially available solution may be used for each of these; such as but not limited to:
310—Nokey.com's electric strike;
320—BMW E32 doorlock microswitch;
330—Alibaba.com's magnetic door-open sensor
340—Accelerometers are known in the art for measuring vibration caused by impacting events. For example, micromachined accelerometers used in portable electronic devices and video game controllers, to detect the position of the device or provide for game input.

Example functionalities, some or all of which may be provided, of the apparatus of FIGS. 1-3, are as follows:

a. An Audio file, which is located locally in the internal storage 90 of the internal computer device 10, may be played by the internal computer device through the speaker 230 of the external panel.

b. A signal, e.g. request, is sent to the server (e.g. server 410 as shown) from the internal computer device 10. The server translates this request into the format employed by the specific remote end user device and then sends this request to a predetermined communication device of a remote user.

c. Request to release an electromagnetic tongue latch of the door is initiated by a predetermined communication device of a remote user. If appropriate, the internal computer 10 may inform the user that the request cannot be fulfilled due to a server disconnect. If, however, the request can be fulfilled, the server sends the request to the internal computer device 10 and the internal computer device 10 sends an electrical pulse via a connection cable, also termed herein “communications and power cable”, to release the latch of the door.

d. A brute force accelerometer signal is sent from the accelerometer 340 typically via a communications and power connection cable to internal computer device 10.

e. Remote user's communication device initiates an audio session. If there is a connection to the server, audio from remote device is streamed to the server with destination parameters. The audio stream is passed from the server to the internal computer device. The audio stream is played by the internal computer device via speaker 230 in the cable connected outdoor panel. If there is no connection to the server, the internal computer 10 informs the remote device of no server connection.

A client application typically resides on an Internet connected computer or a mobile device such as but not limited to a smartphone, tablet, or laptop. In addition, a server application interacting with the client application typically can be installed either on a hosted server or a private local server.

Typically, upon a doorbell ring (press by a caller on call button 240), the system in parallel does the following: speaker 230 plays a ring tune, camera 210 starts video recording and optionally, if selected by user, speaker 230 plays a deterrent sound such as a loud alarm or a recording of a dog barking. The system optionally waits a predetermined or programmed time interval of, say, 5 seconds before sending telephone, SMS, email or other pre-defined notification to the users, via pre-designated user telephone numbers or IP addresses, that a visitor has presented herself at the door. This option is suitable for a user who prefers to handle the event if they are in the house and hence prefers that the system be operative to send a notification message to remote devices only if the event is not handled within X seconds.

The system typically waits, e.g. 20 seconds, for user acknowledgment. Typically, the system is operative to accept, from a user, a determination of what is to happen if there is no remote user response within a certain time period. For example, the system may be operative to accept, from the user, a determination that if there is no remote user response within a certain time period, the notification message is to be sent to someone else.

Typically, each event and action is logged. Logged events and actions typically include some or all of the following: routine events such as doorbell button pressed by caller, door opened by legitimate user, and occasional events such as brute force attempt to open the door, power failure, power resumed, and high temperature (possibly indicating fire). Logged actions typically include each action performed once an event is triggered, such as start video camera, ring the bell in the house, etc. The log thus comprises a historical digital record of every function of the system thereby to provide proof of what occurred and to monitor that the system is functioning correctly. Each log record typically has a timestamp (day, time) which may be displayed to the remote user, allowing remote and local chronological follow-up of how the system is functioning.

The term “legitimate user” is intended to include those users which have been registered and have supplied contact particulars such as telephone number, IP address, mobile telephone number, and even email.

More generally, it is appreciated that the system shown and described herein includes an indoor unit e.g. as shown in FIG. 1, and at least one outdoor unit. Units may for example be connected by a wire line of suitable length e.g. up to 10 meters long. An outdoor unit e.g. as shown in FIG. 2, typically provides audio-visual communications allowing a caller to communicate with the often remotely located user of the system, and/or HMI (human machine interface). A door post unit e.g. as shown in FIG. 3, provides some or all of brute force detection, electromagnetic strike release, door locked detection and door opened alert. The indoor unit e.g. as shown in FIG. 1, provides some or all of power management, Internet connectivity and AV (audio visual) recording capabilities.

Typically, several templates, each comprising an action scheme to be implemented by the system upon occurrence of a predefined event or scenario, are provided. For example, the templates provided may include some or all of the following:

Event templates stored e.g. in the server and performed, when triggered by the relevant event, by the system, may include some or all of the following templates I-VIII:
I. Notify remote users of a doorbell ring
II. Play deterrent audio file when the doorbell rings
III. Suspend remote device doorbell ring notifications (“Honey, I′m home”)
IV. Notify that the door has been opened
V. Notify remote users that there is a power failure
VI. Check if the door is unlocked
VII. Notify remote users that there is a temperature alert.

Example implementations of each of the above event templates are now described:

I. Notify remote users of a doorbell ring: A caller presses call button (240). The electronic board (260) receives the call button pressed event and passes a signal, typically via a suitable communications cable to the Serial port (50), which informs the CPU (10) of the event. The CPU (10) then sends the notification to the server via the WiFi Module 80) or the HSPDA cellular modem (130). The server then sends the notification to the remote device(s) that are defined to receive this notification.

II. Play deterrent audio file when the doorbell rings: A caller presses call button (240). The electronic board (260) receives the call button pressed event and passes a signal, typically via a communications cable, to the Serial port (50), which informs the CPU (10) of the event. The CPU (10) then sends the audio stream via the USB host (70) to indoor speaker (160).

III. Suspend remote device doorbell ring notifications (“Honey, I'm home”): An authorized remote device user presses the “Cancel notification” option. The remote device then sends via the mobile Internet connection a command to the server webservice function. The server then updates the local database that this remote user is not to be notified when a doorbell is rung. While technological solutions such as GPS are available to automatically detect “honey I′m home” situations, in the illustrated embodiment, a user arriving at the monitored facility typically changes the status to “honey I'm home” status manually via any one of the mobile user interfaces such as smartphone or web access.

IV. Notify that the door has been opened: When the door is opened the door magnet detector 320 signals the Serial port (40), typically via a communication and power cable. The serial port informs the CPU (10) of the event. The CPU (10) then sends the notification to the server via the WiFi Module (80) or the HSPDA cellular modem (130). The server then sends the notification to the remote device(s) that are defined to receive this notification.

V. Notify remote users that there is a power failure: Upon a power failure the internal computer 10 and typically all components of the internally disposed subsystem of FIG. 1 is or are, according to certain embodiments, powered by the battery (150). The power supply and charger (140) notify the CPU (10) that power is now being supplied by the battery (10). When power is resumed the CPU (10) is notified again. The CPU (10) monitors the amount of time that there has been a power down signal and no power back on signal. If the elapsed time has exceeded a pre-defined or programmed period e.g. 1 hour, then the CPU (10) sends a notification, via the WiFi Module (80) or the HSDPA cellular modem (130), to the server webservice function. The server then sends the notification to the remote device(s) that are defined to receive this notification. Typically, once power is resumed the CPU 10 zeroes the timer for measuring duration of power down and also transfers any video footage which may have been stored in local memory (90), to the gateway server.

It is appreciated that if a would-be intruder succeeds in cutting a cable in the electric box outside or otherwise disconnecting the electricity supply, a power failure alert may be sent and the system may continue to operate, powered by battery. This enables a user receiving a power failure indication, who fears that the cable may have been cut, to take suitable action e.g. call for police assistance, call neighbors, visit the facility, cops, a neighbor, run home, or set off a deterrent alarm. A would-be intruder may cut the cable in the doorbell channel (duct), disconnecting the inside and outside subsystems of FIGS. 1 and 2 respectively, in which case the relevant user/s may be alerted but may not be able to view or communicate. This situation differs from general power failure alerts in that, when there is a power failure, the backup battery, if provided, allows “continuation of operations”. When the cable is disconnected, typically only the internal computer device is active and provides alert communication, albeit not video viewing or audio communications to the outside door area.

Power failure alerts are useful even if no intruder has caused them and even if other functionalities of the system shown and described herein are operative because the monitored facility has battery backup. For example, if power failure causes refrigeration and freezer systems to be turned off, a home-owner on vacation may need to know.

VI. Check if the door is unlocked: Monitoring whether or not the door is locked typically is achieved by integrating the door lock micro switch (1320) in the door frame and connecting it to the outdoor panel of FIG. 2. According to certain embodiments, the server sends a door unlock request via the Internet to the internal computer device 10 of FIG. 1, via the WiFi module (80) or the HSDPA cellular modem (130). The request is then sent to the CPU (10) which sends a request to report the status of the door lock micro switch (320), typically via a communications cable, to the electronics board (260). The electronics board checks the status (position) of the lock tongue micro switch (320). If the switch is activated (pushed in) then the electronics board (260) reports that the door is locked, and if the switch is not activated then it reports that the door is unlocked. The report is sent, typically via a communications cable, to the CPU (10). The server is then notified of the result (locked/unlocked).

VII. Notify remote users that there is a temperature alert: As part of the system setup, minimum and maximum temperature alert levels are defined and stored in the internal subsystem of FIG. 1. When the thermometer (85) detects that the temperature has exceeded the maximum or has decreased below the minimum defined temperature, the CPU (10) is signaled. The CPU (10) then sends the notification to the server via the WiFi Module (80) or the HSPDA cellular modem (130). The server then sends the notification to the remote device(s) that are defined to receive this notification.

VIII. Intruder smashes door by brute force or drills out the lock: When vibration force is applied to the door, brute force accelerometer (340) typically detects this vibration and signals serial port (40), typically via a communication and power cable. The serial port may then inform the CPU (10) of the event. The CPU (10) may then send the notification to the server via the WiFi Module 80 or the HSPDA cellular modem (130). The server 410 may then send the notification to remote device(s) defined to receive this notification.

The event templates defined in the server are also termed herein “executable functions” e.g. “failure functions” and “rules”.

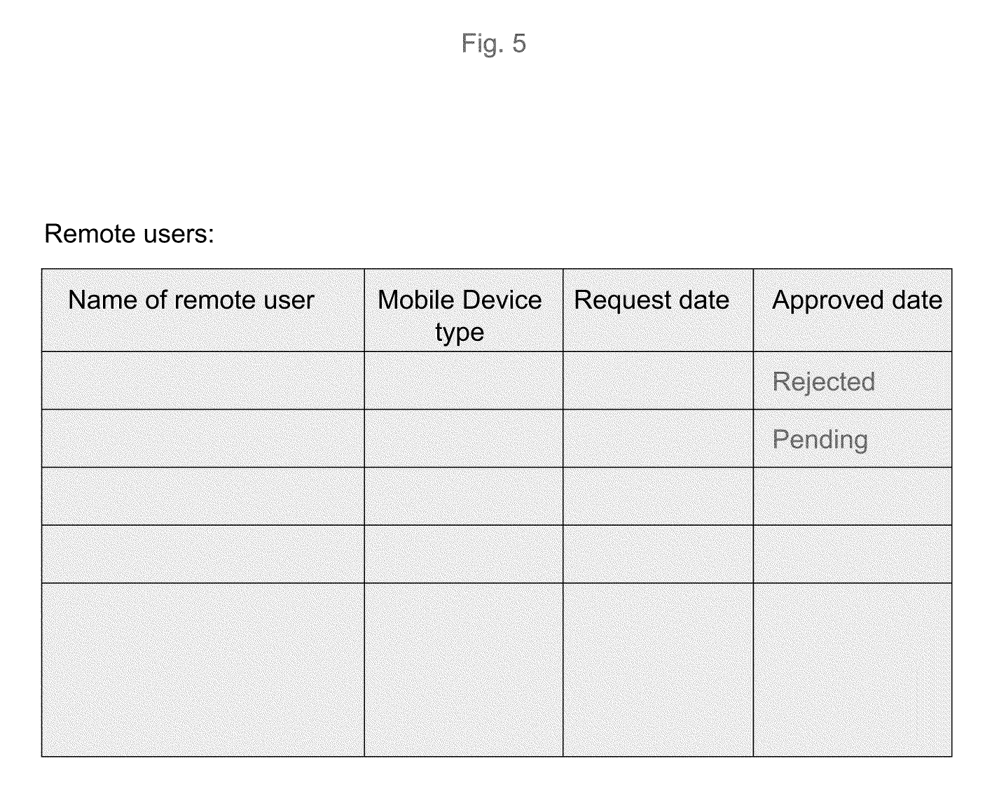

FIG. 5 is an example target table storing particulars of approved remote users of the apparatus of FIGS. 1-4. For each user, typically, a unique name or ID is stored, plus the user's device type e.g. brand and/or model of computer or smartphone (this term being used generally to include any suitable typically mobile personal communication device) employed by the user, plus, optionally, the dates on which the remote user requested to be recognized as a remote user, and the date on which his or her request was recognized and/or current status of the request.

Any suitable technology may be used to associate and authorize remote devices e.g. smartphones or other personal communication devices, to a specific system such as those shown and described herein. For example:

A remote device installs an application implementing the client side of the system shown and described herein. The application may be available on APP stores such as but not limited to Apple, Android, Blackberry, or Microsoft app stores.

The remote device is then prompted to enter or scan a unique identification number of the system its user wants to connect to.

Optionally, this unique ID is cross checked to ascertain that such a device has been installed.

Optionally, a “pair” connection request is sent by the remote device to the server. To ensure that no intruder or imposter is attempting to access the system in the legitimate remote device user's stead, the owner or administrator of the system shown and described herein may receive a notification that a specific device has requested to pair with the system. If the administrator is not readily available to approve this request, the request may remain pending until the administrator becomes available. If the administrator does not recognize the requesting user or for any other reason is not interested in this user connecting to the system, the administrator is optionally able to reject the “pair” request. Once pairing is approved, then this remote device can receive notifications from and give commands to the system shown and described herein.

Information stored by the system, typically on the server side, may include some or all of the following, any or all of which may be used to support Event templates I-VIII above:
a. Doorbell audio chime file
b. Deterrent audio file e.g. dog barking
c. Auto answer audio file (“Who's there”)
d. Events (list of supported events)
e. Actions list (list of supported actions)
f. User interface translation strings (for multi language interface).
g. User profile e.g. including times of day or week in which the user is to be notified; this information may be stored in a scheduling functionality of the server application.
h. Target devices
i. Scenario templates e.g. temporal and/or logical sequence to be followed, for each of several events such as but not limited to sequences I-VIII above.
j. History Logs: typically including all events detected and actions taken by a system installed in an individual monitored site e.g. home.
k. Video recordings: typically documenting occurrences adjacent the door of the monitored dwelling.

A server (410), typically remote from the monitored facility, is typically provided which may serve as the gateway or connection between the remote users and the internal computer device. A suitable software package that provides setup and definition services and feeds the internal computer device with behavior instructions, typically resides on the server. In the absence of such a server, instructions may be conveyed directly to the internal computer device, however, provision of a server (410) provides an indirect connection, therefore providing a higher level of security, as no one has direct access to those components of the main brain of the solution which resides in the server. Use of a server software package also typically eliminates the need for costly input/output peripherals, such as a keyboard and touch screen, as the user can configure and access the internal computer device via the server gateway by connecting to the server via a standard browser and Internet connection.

Communication between the server (410) and the internal computer device (10) of FIG. 1 typically proceeds in accordance with a suitable predetermined communication priority logic. For example, each first attempt at communication may be via a WiFi Internet connection established by WiFi module (80). If WiFi module (80) is unable to connect via WiFi then connection to the server may be made via a cellular data channel established by cell modem (130) (e.g. GSM, EVDO).

A suitable video transfer priority policy is typically defined either by the system or by the user. For example, If there is a usable WiFi Internet connection to the server, e.g. in the absence of a power cut, then, e.g. when defined or requested, video is constantly transferred to and recorded on the server.

If there is no WiFi Internet connection to the server then, typically, only a parameter defined amount of time of video, such as a few minutes or a few hours, is transferred to and recorded on the server.

While in cellular mode, all video recording is typically stored locally on the flash memory SD card (90) of the apparatus of FIG. 1. Once WiFi connection is restored, the video stored on the SD card (90), upon command, is uploaded to the server.

Alternatively or in addition, there may be an on-demand option which forces video to be sent via the cellular data connection. It is appreciated that normally, transfer of data via a WiFi connection is both fast and cost-free, whereas the same transfer via a cellular connection is slower and entails a cost. Therefore, while an available WiFi connection exists, video recording is constantly sent to the server to be stored there and be available for online viewing, or for later review.

Video recording storage is useful for viewing incidents of interest that have occurred in the past and which may be used as evidence of such incidents. So in a case where there is no WiFi Internet connection, the default may be used to upload the video stream from the start of an event for a defined period. For example, a user may want the door entrance to his monitored facility to be video-recorded constantly. However, when the server connection is via a cellular connection, the video stream may be uploaded only for, say, the first 2-3 minutes after a doorbell ring event. It still may be desirable to provide the ability to review video recorded during the maximum duration when the server connection is via the cellular connection, so instead of uploading the video stream, the stream may be recorded locally on the internal SD card (90). Once WiFi connection is resumed, the system may be operative, e.g. responsively, to upload the stream from the SD card (90) thus providing continuous video recording storage.

Typically, the flash memory is large enough to store a long window of video, e.g. several hours of video such as 6, 12 or 20 hours of video. The length of video stored is a function of the SD card (90) capacity. Typically for example, a 32 GB SD card can record between 320 minutes to 720 minutes, depending on the quality of the video.

Software upgrades of the internal computer device (10) of FIG. 1 may be performed. Typically, periodically, as per a pre-determined parameter, the internal computer device (10) queries the server to see if a software upgrade is available. If so, the internal computer device (10) downloads this software version package and installs it. The server is notified by the internal computer device (10) once the upgrade has been successfully implemented. Alternatively, upon being instructed, the server notifies the internal computer device (10) that there is a software version upgrade. The software upgrade process may be performed over the air, using available cellular technology.

Example features of example implementations of the present invention are now described:

a. The external unit of FIG. 2 typically provides video data from a built-in camera (210) either in analog or digital form to the indoor unit of FIG. 1, e.g. for recording/storage and RT (real time) streaming to remote users including mobile devices.

b. Bidirectional audio communication (voice grade) is provided to/from the indoor unit of FIG. 1.

c. accelerometer data e.g. sensed by a brute force accelerometer or vibration sensor (340) (FIG. 3) may be reported to the indoor unit of FIG. 1. To detect brute force attack, the unit may interface (e.g. via an I2C interface) to the accelerometer sensor (340) in the door.

d. For low light conditions (depending on camera) the unit may detect insufficient illumination and use internal light source (LED, etc.) if an external light source is unavailable. The unit may control an external light source (for example in an apartment building) when helpful for video quality, or by a command from indoors.

e. The external unit may detect motion (on video) in order to trigger recording and/or in order to report such motion to the indoor unit.

f. Typically, the internal computer device constantly “talks” with the outdoor unit. If this communication channel is broken, then a loss of communication occurs between at least one externally disposed unit e.g. the external camera (if one is used) currently “talking to” and the indoor unit, such that the communication loss may be reported to the server, e.g. via an Internet connection, either WiFi or cellular.

g. The external unit may include a video camera (210) and microphone (220) capable of recording video (analog or digital) and voice grade audio respectively, e.g. to a local SD card (90).

h. The unit may be connected to the Internet e.g. using LAN and/or WLAN connection and cellular. A GSM modem may be used as a backup.

i. The unit optionally includes an internal SD/SDHC storage unit for storing data locally when there is no external connection and/or when there is no low-cost connection.

j. Optionally, an IP-camera and/or analog (composite) video camera may be provided, with some or all of:
Cellular modem integration
AV storage
h.264 video encoder
AV streaming to mobile
Power management
Communication protocol and interface design for outdoor unit.

However, in the illustrated embodiment, the camera is included in the external panel and no IP camera is required since the internal computer device handles the video stream.

k. The outdoor unit of FIG. 2 may include a CMOS sensor/camera interface having communication with the indoor unit.

l. Typically, multiple USB host connections are provided such that it is possible to connect a second camera directly to the indoor computer device (10) of FIG. 1, thus enabling viewing via this second camera of a caller who has succeeded in immobilizing the outdoor panel or otherwise deactivating video camera (210).

m. Server (410) may be in a remotely located server farm or may be in the monitored facility e.g. home, typically equipped with battery backup.

n. Optionally, a user e.g. family member can reconfigure the system either from the home computer or remotely. The remote APP may have a call-forwarding function allowing the user to transfer a notification to other users/family member(s).

o. Optionally, regardless of alerts having been received or not, a remote user can initiate a check of some or all of: house temperature, whether or not the door is locked, and whether or not there is electricity power.

Any suitable GUI may be provided as an application on the remote user's personal communication device e.g. smartphone, in order to allow the remote user to interact with the system. For example, the GUI may allow the remote user to select an option, represented e.g. by an icon, from among some or all of the following:
a. Activate deterrent alarm
b. Show me a live video stream of the space in front of the door of the monitored facility
c. Check if the door of the monitored facility is unlocked (e.g. by checking state of micro switch (220)
d. Change settings e.g. on smartphone screen, typically from the server
e. Begin an audio stream typically enabling user to both talk to and listen to a caller at the monitored facility
f. send image of caller to my (say) smartphone including a still image of whoever is at the door
g. open the door of the monitored facility—“buzzer”
h. show history of door events, e.g. all door events or only a subset thereof such as only today's events or only events not yet viewed by this user.

It is appreciated that certain embodiments of the invention shown and described herein have various advantages vis a vis the prior art including some or all of the following:

a. reduced frequency of physical visits to the monitored facility e.g. by owners, security company patrols, or non-resident family members, to investigate if an alarm was false or not. Remote users can determine from afar that certain alarms are false alarms, by reviewing the historical stream (log) and utilizing sensors such as the door locked sensor and of brute force trigger and door bell ring (a thief often checks if anybody is home). Remotely viewing the video stream recording events at the entrance may also enable a remote user e.g. security service to identify false alarms without visiting the facility. For example, it is possible to see whether someone is actually trying to break down the door or whether someone simply kicked the door and moved on. Remote users can also ask verbally if anybody is there, or otherwise act remotely so as to scare off potential intruders.

b. The system is inexpensive enough for SOHO (small office/home office) installations.

c. ability to remotely check if a door, e.g. of a forgetful elderly family member, is locked, no matter where the concerned individual is currently physically located. Where the user does not have a WiFi connection to the Internet, a LAN (wired) connection or a cellular connection is used.

d. an immobile person need not avail themselves of services of another, and need not leave the door unlocked, in order to receive callers, including service people.

The immobile home patient can receive a bell ring notification on his/her smartphone, tablet or laptop, view who is at the door, speak to them if s/he wishes, and open the door by releasing the electromagnetic latch mechanism.

e. If an elderly person triggers her alarm bracelet and an emergency crew is sent to the home, the crew might not be able to enter because the door is locked.

However, embodiments of the present system enable a remotely located family member to remotely open the door for the emergency crew (unless it is bolted).

f. The gateway server provides services, e.g. defining the templates, that if implemented in the internal computer device would require provision of additional (costly) resources such as a screen, input device, embedded software in the monitored facility.

It is appreciated that terminology such as “mandatory”, “required”, “need” and “must” refer to implementation choices made within the context of a particular implementation or application described here within for clarity and are not intended to be limiting since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

Conversely, features of the invention, including method steps, which are described for brevity in the context of a single embodiment or in a certain order may be provided separately or in any suitable sub combination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery. It is appreciated that in the description and drawings shown and described herein, functionalities described or illustrated as systems and sub-units thereof can also be provided as methods and steps there within, and functionalities described or illustrated as methods and steps there within can also be provided as systems and sub-units thereof. The scale used to illustrate various elements in the drawings is merely exemplary and/or appropriate for clarity of presentation and is not intended to be limiting.

1. A dual-communication mode door monitoring system operative in conjunction with a computer network and a cellular network, the system comprising:
sensory apparatus for collecting data regarding at least one event in which a visitor has come to a door of a monitored facility, the sensory apparatus having a wireless link with the computer network and a cellular communication channel with the cellular network;
at least one node on a computer network and on a cellular network operative for receiving alerts including data from said sensory apparatus; and
a communicator, co-located with the sensory apparatus, which is operative to send the data regarding the event to the node, a priori via the wireless link and, as a backup, via the cellular communication channel.

2. A system according to claim 1 wherein said node comprises a server operative for activating at least one system response responsive to said data.

3. A system according to claim 2 which is backed up by battery power to ensure continuity of monitoring and action.

4. A system according to claim 3 and also comprising a power failure identifier which identifies a power failure and sends information regarding the power failure to the node via the battery powered cellular channel.

5. A system according to claim 1 wherein said computer network comprises the World Wide Web and said wireless link comprises WiFi.

6. A computerized alarm generator system, operative in conjunction with a door monitoring system including an internal computer device disposed inside a monitored facility and external sensor apparatus, disposed externally of the monitored facility, for collecting data regarding an event in which a visitor has come to a door of the monitored facility and transferring the data to the internal computer device,
the computerized alarm generator system comprising:
a disconnection sensor sensing a disconnection between the external sensory apparatus and the internal computer device; and
a communicator, co-located with the disconnection sensor, operative for sending information regarding the disconnection to a computerized device.

7. A computerized door monitoring system comprising:
a micro switch operatively associated with a lock on a door of a monitored facility, so as to sense whether or not the door is locked; and
a programmed alert generator operative to send an alert to at least one predetermined alert recipient if the door is not locked and at least one predetermined condition is true.

8. A system according to claim 7 wherein said predetermined condition comprises a time trigger defining at least one time at which an alert is to be sent if the door is not locked.

9. A system according to claim 2 wherein said at least one system response includes notifying at least one remote user that connection between an outdoor subsystem sensing information re a caller to the monitored facility, and an indoor computer device disposed internally to the monitored facility, has been interrupted.

10. A computerized door monitoring system comprising:
a sensor operative to sense a brute force attempt to batter down a door; and
an alert generator, actuated by the sensor, and operative to alert a remote alert recipient of the brute force attempt to batter down a door.

11. A system according to claim 2 and also comprising upgrading the device software, via the server.

12. A system according to claim 4 wherein said data includes video data and wherein a video transfer priority policy which depends on input from said power failure identifier, governs transfer of video for storage at said node, including at least sometimes transferring video to the node while the power failure identifier indicates there is no power failure, and at least sometimes refraining from transferring video to the node while the power failure identifier indicates there is a power failure.

13. A system according to claim 12 wherein the video data is generated by a video camera, and wherein said system includes a local video data repository, co-located with the video camera, and wherein the video data is stored at the node while the power failure identifier indicates there is no power failure; the video data is stored at the local video data repository while the power failure identifier indicates there is a power failure; and the video data stored at the local video data repository is optionally uploaded to the node when the power failure identifier indicates there is no longer a power failure.

14. A system according to claim 12 wherein, if the wireless link is useable, the video is constantly transferred to and recorded on the node and otherwise, only a pre-defined time-window of video is transferred to and recorded on the node.

15. A system according to claim 7 wherein the door has a latch including a tongue and wherein the micro switch is positioned to sense whether the tongue of the latch is in a first position extending into the door frame indicating the door is locked or a second retracted position indicating that the door is unlocked.

16. A system according to claim 2 wherein said at least one system response includes notifying at least one remote user of a doorbell ring.

17. A system according to claim 2 wherein said at least one system response includes playing a deterrent audio file to a caller, when a doorbell is rung by the caller.

18. A system according to claim 2 wherein said at least one system response includes suspending doorbell ring notifications to remote devices.

19. A system according to claim 2 wherein said at least one system response includes notifying at least one remote user that the door has been opened.

20. A system according to claim 2 wherein said at least one system response includes notifying at least one remote user that there has been a power failure.

21. A system according to claim 2 wherein said at least one system response includes checking if the door is unlocked.

22. A system according to claim 2 wherein said at least one system response includes notifying at least one remote user that temperature in the monitored facility has exceeded pre-set limits.

23. A system according to claim 6 wherein access particulars of at least one computerized device to which the information regarding a disconnection event is to be sent, are stored in a server which also has logic which defines when each computerized device is to be notified.

24. A dual-communication mode door monitoring method operative in conjunction with a computer network and a cellular network, the method comprising:
Providing sensory apparatus operative for collecting data regarding at least one event in which a visitor has come to a door of a monitored facility, the sensory apparatus having a wireless link with the computer network and a cellular communication channel with the cellular network;
Providing at least one node on a computer network and on a cellular network operative for receiving alerts including data from said sensory apparatus; and
Providing a communicator, co-located with the sensory apparatus, which is operative to send the data regarding the event to the node, a priori via the wireless link and, as a backup, via the cellular communication channel.

25. A computerized alarm generator method, operative in conjunction with a door monitoring system including an internal computer device disposed inside a monitored facility and external sensor apparatus, disposed externally of the monitored facility, for collecting data regarding an event in which a visitor has come to a door of the monitored facility and transferring the data to the internal computer device, the computerized alarm generator method comprising:
Providing a disconnection sensor sensing a disconnection between the external sensory apparatus and the internal computer device; and
Providing a communicator, co-located with the disconnection sensor, operative for sending information regarding the disconnection to a computerized device.

26. A computerized door monitoring method comprising:
Providing a micro switch operatively associated with a lock on a door of a monitored facility, so as to sense whether or not the door is locked; and
Providing a programmed alert generator operative to send an alert to at least one predetermined alert recipient if the door is not locked and at least one predetermined condition is true.

27. A computerized door monitoring method comprising:
Providing a sensor operative to sense a brute force attempt to batter down a door; and
Providing an alert generator, actuated by the sensor, and operative to alert a remote alert recipient of the brute force attempt to batter down a door.

28. A computer program product, comprising a computer usable medium having a computer readable program code embodied therein, said computer readable program code adapted to be executed to implement a method as shown and described herein, said method comprising steps as shown and described herein.
